(19) United States
(12) Patent Application Publication
(10) Pub. No.: US 2015/0029038 A1
(43) Pub. Date: Jan. 29, 2015

(54) Method and Apparatus for Message Delivery Via HD Radio

(71) Applicant: Ford Global Technologies, LLC, Dearborn, MI (US)

(72) Inventors: Perry Robinson MacNeille, Lathrup Village, MI (US); Yimin Liu, Ann Arbor, MI (US); Oleg Yurievitch Gusikhin, West Bloomfield, MI (US); Paul Duncan McCarthy, Ann Arbor, MI (US); John Matthew Ginder, Plymouth, MI (US)

(73) Assignee: Ford Global Technologies, LLC, Dearborn, MI (US)

(21) Appl. No.: 13/951,686

(22) Filed: Jul. 26, 2013

(51) Int. Cl. H04H 60/61; H04H 60/45; H04H 40/18; B60Q 9/00; H04H 60/33

(52) U.S. Cl. CPC H04H 60/61; B60Q 9/00; H04H 60/33; H04H 40/18; H04H 60/45
USPC 340/901

(57) ABSTRACT

A system includes a processor configured to receive a message included with a digital radio signal. The processor is also configured to examine a message header to determine if the message is intended for receipt at a receiving vehicle. The processor is further configured to discard the message if not intended for receipt at the receiving vehicle. Also, the processor is configured to process the message if intended for receipt at the receiving vehicle and deliver the processed message to a vehicle occupant.

### TECHNICAL FIELD

The illustrative embodiments generally relate to a method and apparatus for message delivery via HD radio.

### BACKGROUND

Vehicle computing and infotainment systems provide many advantages to a modern driver. The delivery of on-demand content, internet access, navigation directions, targeted/tailored advertising and other data-based features allows for an enhanced driving experience, and a wealth of information at a driver's fingertips. One of the biggest hang-ups with delivery of all this content is, at this point, the availability of bandwidth.

Since the data is commonly transferred to a vehicle using a cellular phone or portable hot-spot connection, there is a potential limit to how much data can be delivered. Additionally, these devices are not in an “always on” state when the vehicle is running That is, if the provider device is powered down or disconnected from the vehicle computing system (VCS), the system cannot communicate with a remote source for transmission or reception of data.

Other sources can be used for data transmission, however, at least in a general sense. U.S. Application 2010/044090 generally relates to a digital radio broadcast system including a processing system that receives first audio content, first program data identifying a first item for the first audio content, second audio content, and second program data identifying a second item for the second audio content such that a start of the first program data is received at the processing system within 0.5 seconds of a start of the first audio content. A digital radio broadcast signal including the audio content and the program data is processed for digital radio broadcast transmission via a transmitter. The processing system stops delivery of the first program data to the transmitter upon receipt of the second program data, the first program data thereby being truncated, and begins delivery of the second program data to the transmitter. A digital radio broadcast receiver can tag content of interest based on a user command registered at the receiver.

Additionally, U.S. Application 2005/0202781 generally relates to a system for providing enhanced radio content to a remote user. The system includes at least one input that receives non-radio input; and, at least one output interconnected to the at least one input via a hub, wherein the at least one output receives the enhanced radio content via the hub after at least one manipulation of the non-radio input by the hub to form the enhanced radio content, wherein the at least one manipulation is in accordance with the at least one non-radio input.

### SUMMARY

In a first illustrative embodiment, a system includes a processor configured to receive a message included with a digital radio signal. The processor is also configured to examine a message header to determine if the message is intended for receipt at a receiving vehicle. The processor is further configured to discard the message if not intended for receipt at the receiving vehicle. Also, the processor is configured to process the message if intended for receipt at the receiving vehicle and deliver the processed message to a vehicle occupant.

In a second illustrative embodiment, a computer implemented method includes receiving a message included with a digital radio signal. The method also includes examining a message header, via a vehicle computing system, to determine if the message is intended for receipt at a receiving vehicle. Further, the method includes discarding the message if not intended for receipt at the receiving vehicle. The method additionally includes processing the message if intended for receipt at the receiving vehicle and delivering the processed message to a vehicle occupant.

In a third illustrative embodiment, a computer readable storage medium stores instructions that, when executed by a processor, cause the processor to perform a method including receiving a message included with a digital radio signal. The method also includes examining a message header, via a vehicle computing system, to determine if the message is intended for receipt at a receiving vehicle. Further, the method includes discarding the message if not intended for receipt at the receiving vehicle. The method additionally includes processing the message if intended for receipt at the receiving vehicle and delivering the processed message to a vehicle occupant.

### BRIEF DESCRIPTION OF THE DRAWINGS

FIG. 1 shows an illustrative vehicle computing system;

FIG. 2 shows an illustrative example of a message transmission process;

FIG. 3 shows an illustrative example of a message preparation process;

FIG. 4 shows an illustrative example of a message reception system;

FIG. 5 shows an illustrative example of a message reception process; and

FIG. 6 shows an illustrative example of a communication manager flow.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

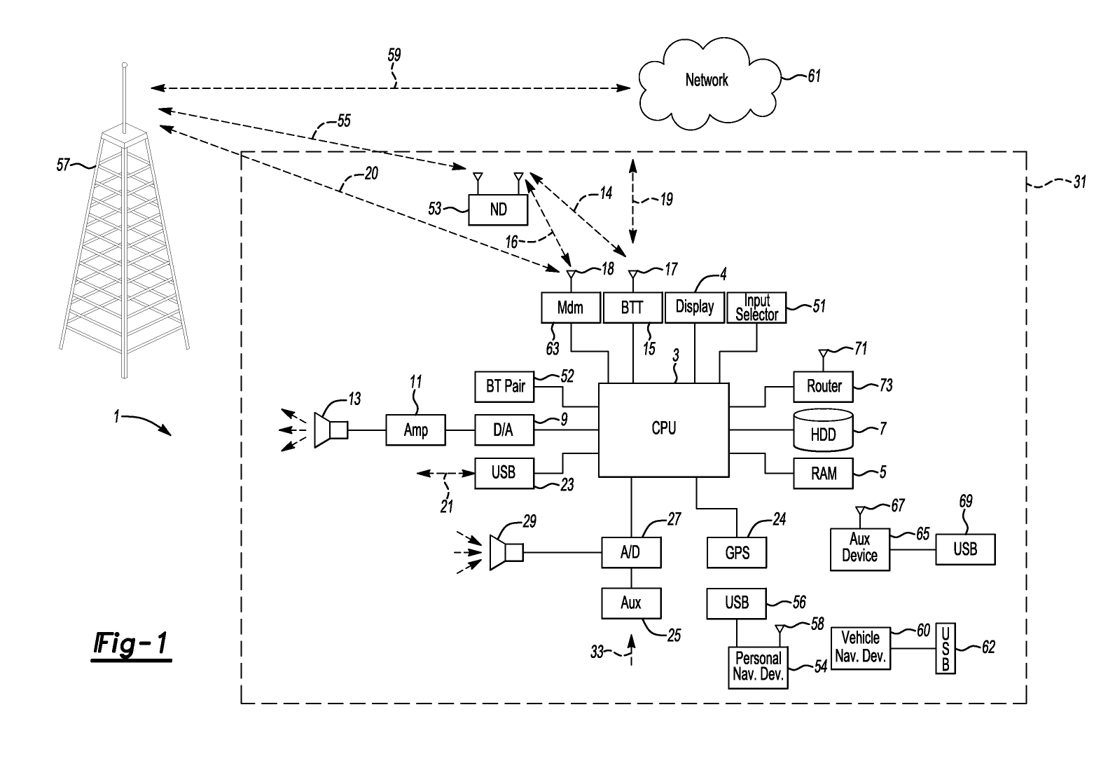

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, audible speech and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory.

The processor is also provided with a number of different inputs allowing the user to interface with the processor. In this illustrative embodiment, a microphone 29, an auxiliary input 25 (for input 33), a universal serial bus (USB) input 23, a global positioning system (GPS) input 24 and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a controller area network (CAN) bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as personal navigation device (PND) 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, personal digital assistant (PDA), or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the central processing unit (CPU) is instructed that the onboard BLUETOOTH transceiver will be paired with a BLUETOOTH transceiver in a nomadic device.

Data may be communicated between CPU 3 and network 61 utilizing, for example, a data-plan, data over voice, or dual-tone multi-frequency (DTMF) tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as infrared data association (IrDA)) and non-standardized consumer infrared (IR) protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of with Code Domain Multiple Access (CDMA), Time Domain Multiple Access (TDMA), Space-Domian Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (firewire), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

While bandwidth via a wireless connection to a vehicle, established, for example, through a phone connection or WiFi connection, may be limited based on connectivity, data limits, voluntarily or involuntarily imposed transfer limitations, etc., there may be other solutions for data transfer to a vehicle. Specifically, in the illustrative embodiments, an high definition (HD) radio signal is used to transfer data from a remote source to a vehicle.

An HD radio signal has the capability to carry more than enough data to send a message to a vehicle, and, in conjunction with the illustrative embodiments as described herein, the signal can be used to transmit a message to a specified vehicle or vehicles.

Simple text messages occupy an incredibly nominal amount of space in terms of modern storage and bandwidth. While this may seem to mean that conventional data transfer (wireless via cellphone, data over voice, WiFi) should suffice for delivery of message, a vehicle may not always have such connectivity available. An HD radio receiver, on the other hand, can be setup so as to be receive-enabled any time the vehicle is powered (or, if desired, even when it is not powered).

Messages can be encoded with a header that designates a specific vehicle or group of vehicles for receipt of the message. The message can then be broadcast over an HD radio frequency. All non-designated vehicles, which may at least have the messages arrive thereat, can simply ignore the messages and discard the data. Targeted vehicles can decode an encoded message selected for delivery to those vehicles and deliver the messages to the occupant.

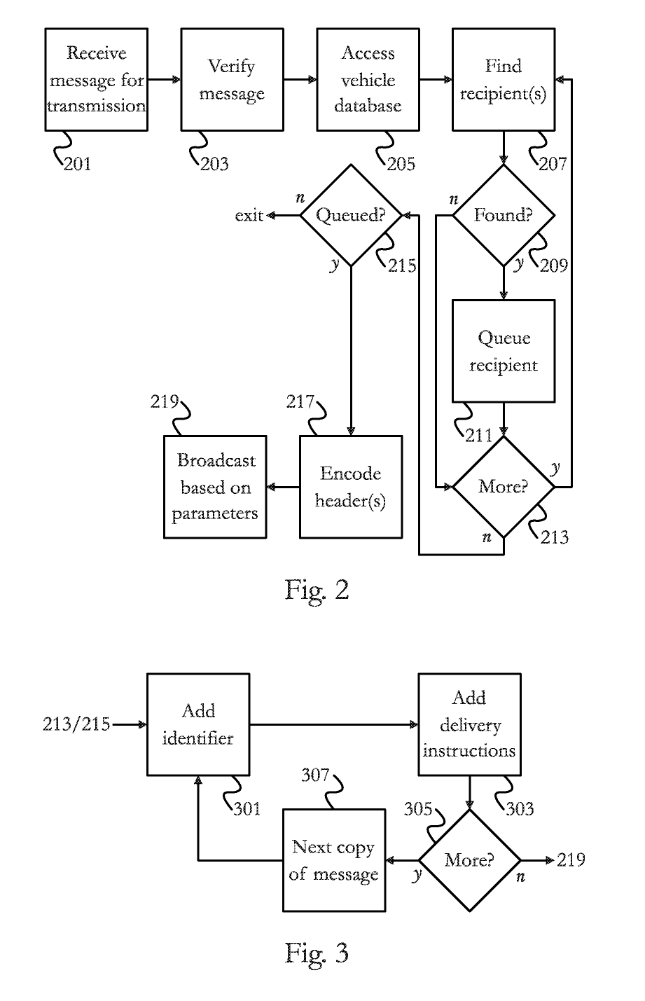

FIG. 2 shows an illustrative example of a message transmission process. In this illustrative example, a system or user develops a message for delivery to a vehicle/occupant. Occupants can be identified by vehicles or other signatures and these identifiers can be provided to both the messages and to vehicles. Vehicle receivers can receive messages designated for a vehicle, for example, by a known vehicle identifier such as vehicle identification number (VIN). This could be useful for delivering recall messages, passenger alerts, etc. The receivers can also be provided with identifiers for people present in the vehicle or logged into a vehicle system. Corresponding messages can then be received by the vehicle, if the messages identify a present/logged-in party.

The message sending process shown in this example first receives a message for transmission to a vehicle 201. As noted, this can be a personally generated message or, for example, an automatically generated message designed for delivery to one or more vehicles. Common examples of automated messages that may be generated include, for example, but are not limited to, loan payment reminders for an individual vehicle and recall notifications for a class of vehicles.

In this embodiment, the message is also verified as being generated by an approved source 203. Since the transmission is made to the vehicle from, for example, an OEM provided server, the OEM may have some interest in verifying the permissibility of message transmission prior to sending the message. In this illustrative example, the message identifies a vehicle or class of vehicle for receipt of the message, although as noted other identifying designations can be used.

From a vehicle database 205, one or more vehicles designated for receipt of the message are retrieved 207. For example, if a message about a due loan payment on a 2012 Ford Focus is sent, the process may include a known vehicle VIN or other identifying information, that can be used to look up a delivery signature that will be recognized by the vehicle. In another instance, if a message that a bad fuse exists in an entire line of vehicles is to be sent, the database can be used to pull a series of identifiers relating to all the vehicles. Or, for example, each vehicle may be provided with several receipt conditions, one relating to model year, make, model, VIN, etc. Thus, messages that match some or all of these criteria can then be received and processed by the vehicle.

If the selected vehicle/user/etc. is found in the database 209, the process may queue that user in a list of recipients 211. If no user is found, the process may check to see if there are more users 213, which is also a check that may be made after a given user/vehicle has been queued. Until there are no more designated recipients, this process can continue.

Once there are no more recipients remaining, the process may check to see if there are any known recipients queued for message receipt 215. If there are, the process may encode the header(s) of the message(s) so that the designated vehicle(s) can receive the messages 217. This can help ensure that the messages are delivered to the appropriate recipients. The process can then use an HD radio signal to broadcast the message(s) based on certain parameters 219. For example, without limitation, messages may be broadcast once an hour, once a day, or based on any other appropriate model. Since the messages may comprise very small data packets, broadcast of thousands or more messages in rapid succession may be possible. Re-broadcast helps ensure that a message likely is received by a designated HD radio receiver at some point when the receiver is powered. Of course, confirmation messages, sent over conventional channels, can be used to verify receipt and/or delivery of a given message as well.

FIG. 3 shows an illustrative example of a message preparation process. In this illustrative example, an identifier can be added to a message 301 that identifies which HD receiver/vehicle/user is intended to receive the message. This identifier is, in this example, what the HD receiver will use to determine whether or not to discard or process a particular message. In addition to an identifier, a set of delivery instructions may be added 303. For example, if a message is about a late car loan payment, the process may add instructions that the message is only to be delivered when the borrower is in the vehicle and, for example, is detected to be alone in the vehicle. This could help avoid a potentially embarrassing situation.

The process then checks to see if more messages remain for encoding, identification, instructions, etc. 305. Additional messages are processed 307 until no more messages remain, at which point the delivery can occur. Delivery could also be on a message by message basis, if the system processes the messages one at a time instead of as a batch.

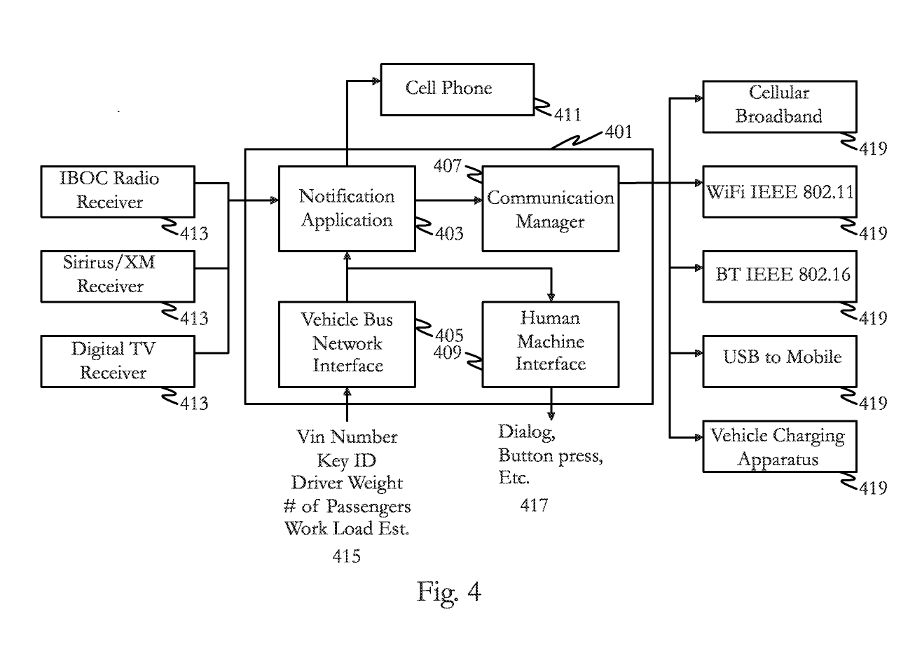

FIG. 4 shows an illustrative example of a message reception system. In this illustrative system, several useful components are shown that can assist in the reception and delivery of HD radio messages targeted for delivery to an identified recipient. For example, any number of HD (high bandwidth) type sources that receive a digital signal can be used for delivery, such as, but not limited to, IBOC radio receivers, Sirius/XM receivers, digital TV receivers, etc. 413.

These receivers feed a received signal, including a message, into a notification application 403. The notification application can utilize a VIN number or other driver/occupant/vehicle identifiers 415 to determine which messages to utilize and which messages to discard. These identifiers can be delivered over a vehicle bus network, such as the CAN bus 405.

System outputs can be provided as a human machine interface (HMI) 409, which can also provide inputs 417 usable to identify a user or to identify whether or not a message should be delivered. The notification application can also use a cellular phone 411 as an identifier and/or an output/delivery source. Further, the notification application can, through the communication manager 407, recognize and utilize various wireless networking capabilities 419 to deliver a message to another source. These networking capabilities can also, when online, be used to deliver a notification to the sending entity or other party, indicating that a particular message has been received and/or delivered.

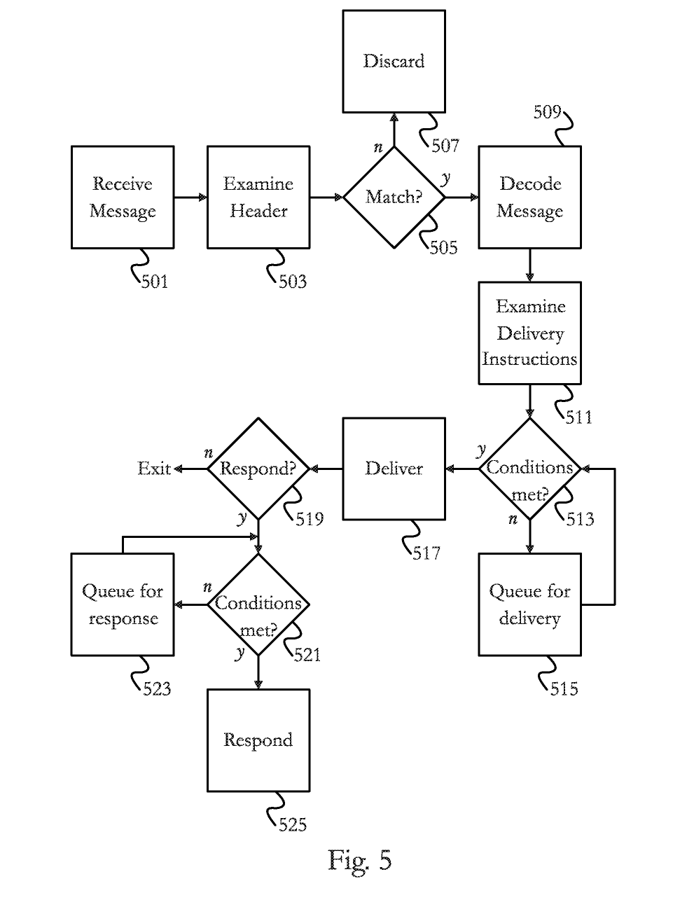

FIG. 5 shows an illustrative example of a message reception process. This illustrative example provides a non-limiting instance of a process for receiving a variety of messages and vetting them for storage and/or delivery. As previously noted, hundreds or even thousands of messages may be received by a given system over the course of a session, but all or most of these message will likely be intended for other recipients/destinations. Accordingly, it may be useful to have a quick method of discarding irrelevant messages and only processing the ones intended for delivery to a particular system. This helps protect the privacy of the messages as well.

In this illustrative example, a message is received 501 which includes a header indicating a particular destination/recipient. The process examines the header 503 to determine if the current recipient matches the intended recipient. If there is a match 505, the processing will continue, otherwise the message is discarded 507 and the process can move to a next incoming message.

If the message matches the current recipient, the process may then decode the message 509. It may be useful to encode the messages with some form of key encryption to ensure that only an intended recipient can decode the message. Since the messages may be broadcast to tens of thousands of potential recipients, with only one intended target, the encryption can add a layer of assurance that no one, other than the intended recipient, is able to receive, decode and read the message.

Once the message has been decoded, the delivery instructions, if any, can then be examined 511. These instructions can aid the system in delivery of the message by specifying, for example, a delivery medium and delivery conditions. The instructions may also have response instructions included therewith, that indicate if/when/how a system should notify a sender that a message was received and/or delivered.

If there are any conditions for delivery, and if the conditions are met 513, the message may be delivered to the recipient 517. If the conditions are not met, the message may be queued 515 so that it can be delivered at a later point in time. For example, some messages may only be delivered in conditions where a single user (possibly also specifically identifier) is present in the vehicle. Other messages may have distraction-related factors affecting delivery. Or messages may only be delivered when a vehicle is not in motion. These are just a few examples of conditional delivery. Also, some messages may be delivered via a vehicle HMI, whereas others may be delivered via a cell phone or other connected medium.

If the message also has a response tag 519, there may be a response to be delivered when the message is delivered to the recipient. In this example, the response is upon delivery, however it is also possible to deliver a response upon receipt.

If there are conditions associated with the response, the process will wait until these conditions are met 521. For example, without limitation, the response may require some user input, or, for example, the response will likely require some connection to a remote network. While a message can be received anywhere a radio signal is present, sending a response may be limited to situations where an outside network can be reached for outgoing message. If the conditions are not yet met, the process may queue the message for response 523. Once the conditions have been met, the process may send the response 525.

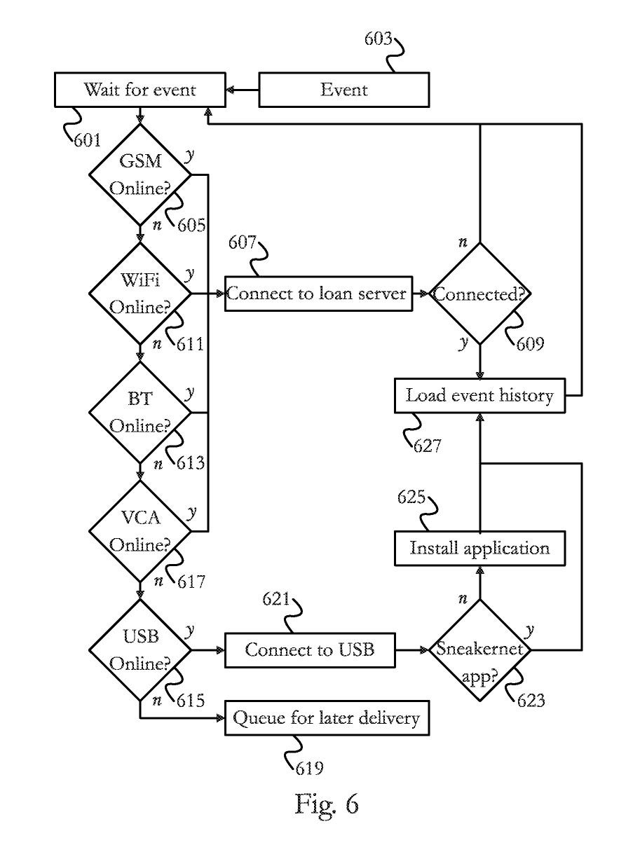

FIG. 6 shows an illustrative example of a communication manager flow. In this illustrative embodiment, the process runs on a receiving device designed to receive an HD radio signal or similar signal. The process is used to transmit receipt confirmation back to a sending entity once a notification has been received. In this illustrative example, the process receives a notification of a due loan-payment.

In this example, the response process waits for a particular triggering event 601. In this example, the event is the presentation of the notification 603. Once the notification has been displayed or presented to the recipient/occupant the process will check to see if one of a number of various response formats is available. The response is sent via a remote network connection, so the response can use a variety of available transport mediums, depending on system design. In this illustrative example, these mediums include Global Satellite Mobile Communications 605, wireless networking 611, Bluetooth 613, a VCA connection 617 or USB 615.

In the case of all the examples other than the USB, the process uses the connection to connect to a loan server 607. Other remote servers can be contacted when other data is being responded to. In at least one embodiment, the process can connect to a central server that returns “response” messages to whichever entity used the central server to send out the messages. Any suitable configuration of return processing may be used.

If the process is successful in connecting to the remote server 609, the process can then load event history 627 into the remote server. This can be used to demonstrate when a message was received, when a message was delivered, what, if any, response was provided for a message by the occupant, etc.

In the case of a USB connection, since the USB connection does not generally provide internet or network connectivity, a sneakernet application may be used. Sneakernet is a general term describing use of media in place of network connectivity for transfer of information. The process determines if a suitable application for use of sneakernet transfer is installed 623. If the application exists, then the process can upload the relevant information to a USB drive. If the application does not exist, then the process can act to install an appropriate application 625 and then upload the information. If no remote connection or connection proxy exists, the information can be queued for later delivery.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a processor configured to:
receive a message included with a digital radio signal;
examine a message header to determine if the message is intended for receipt at a receiving vehicle;
discard the message if not intended for receipt at the receiving vehicle;
process the message if intended for receipt at the receiving vehicle; and
deliver the processed message to a vehicle occupant.

2. The system of claim 1, wherein the processor is further configured to receive delivery conditions included with the message.

3. The system of claim 2, wherein the processor is further configured to deliver the message only once the delivery conditions have been met.

4. The system of claim 2, wherein the delivery instructions include identification of a specific vehicle occupant identifiable by a receiving vehicle system.

5. The system of claim 2, wherein the delivery instructions include restricting delivery until a single occupant, determinable by a vehicle system, is present in the receiving vehicle.

6. The system of claim 1, wherein the processor is configured to detect a network connection capable of outgoing communication and utilize the network connection to transmit a receipt confirmation following receipt of the message intended for receipt at the receiving vehicle.

7. The system of claim 1, wherein the processor is configured to detect a network connection capable of outgoing communication and utilize the network connection to transmit a delivery confirmation following delivery of the processed message.

8. The system of claim 1, wherein the processor is configured to deliver the message to a vehicle output.

9. The system of claim 1, wherein the processor is configured to deliver the message to a user device in communication with the vehicle.

10. A computer implemented method comprising:
receiving a message included with a digital radio signal;
examining a message header, via a vehicle computing system, to determine if the message is intended for receipt at a receiving vehicle;
discarding the message if not intended for receipt at the receiving vehicle;
processing the message if intended for receipt at the receiving vehicle; and
delivering the processed message to a vehicle occupant.

11. The method of claim 10, wherein the processor is further configured to receive delivery conditions included with the message.

12. The method of claim 11, wherein the processor is further configured to deliver the message only once the delivery conditions have been met.

13. The method of claim 11, wherein the delivery instructions include identification of a specific vehicle occupant identifiable by a receiving vehicle system.

14. The method of claim 11, wherein the delivery instructions include restricting delivery until a single occupant, determinable by a vehicle system, is present in the receiving vehicle.

15. The method of claim 10, further including detecting a network connection capable of outgoing communication and utilizing the network connection to transmit a delivery confirmation following delivery of the processed message.

16. A computer readable storage medium storing instructions that, when executed by a processor, cause the processor to perform a method comprising:
receiving a message included with a digital radio signal;
examining a message header, via a vehicle computing system, to determine if the message is intended for receipt at a receiving vehicle;
discarding the message if not intended for receipt at the receiving vehicle;
processing the message if intended for receipt at the receiving vehicle; and
delivering the processed message to a vehicle occupant.

17. The computer readable storage medium of claim 16, wherein the processor is further configured to receive delivery conditions included with the message.

18. The computer readable storage medium of claim 17, wherein the processor is further configured to deliver the message only once the delivery conditions have been met.

19. The computer readable storage medium of claim 17, wherein the delivery instructions include identification of a specific vehicle occupant identifiable by a receiving vehicle system.

20. The computer readable storage medium of claim 17, wherein the delivery instructions include restricting delivery until a single occupant, determinable by a vehicle system, is present in the receiving vehicle.
